(19) United States
(12) Patent Application Publication
(10) Pub. No.: US 2010/0166519 A1
(43) Pub. Date: Jul. 1, 2010

(54) CLAMPING METHOD FOR WORKPIECES USED FOR THE PRODUCTION OF COMPRESSOR OR TURBINE WHEELS

(76) Inventor: Guenter LEITOLD, Fussach (AT)

Correspondence Address: MCGLEW & TUTTLE, PC, P.O. BOX 9227, SCARBOROUGH STATION, SCARBOROUGH, NY, 10510-9227, US

(21) Appl. No.: 12/443,888

(22) PCT Filed: Oct. 1, 2007
(86) PCT No.: PCT/CH2007/000483

§ 371 Date: Jan. 19, 2010

(30) Foreign Application Priority Data
Oct. 2, 2006 (CH) 1570/06

(51) Int. Cl. B23C 3/04

(52) U.S. Cl. 409/131

(57) ABSTRACT

A milling method is disclosed for machining a workpiece of a compressor or turbine wheel in a machine tool. The contour of flow-conducting sections of the compressor or turbine wheel is machined using a rotating milling tool on the workpiece that is accommodated in a workpiece support and is fastened relative thereto for the production process. In order to increase the possibilities to automate the method, the workpiece (8) is placed, by a positioning aid, in a certain position within the workpiece support in a positioning step. The position is used for a subsequent production process and is at least radially predetermined relative to a longitudinal axis. The workpiece is fastened within the machine tool in an axial direction relative to the workpiece support in a clamping step that differs from the positioning step.

### CROSS REFERENCE TO RELATED APPLICATIONS

This application is a United States National Phase application of International Application PCT/CH2007/000483 and claims the benefit of priority under 35 U.S.C. §119 of Swiss Patent Application CH 1570/06 filed Oct. 2, 2006, the entire contents of which are incorporated herein by reference.

### FIELD OF THE INVENTION

The invention relates to a milling method for machining a workpiece of a compressor or turbine wheel in a machine tool, in which the contour of flow-conducting sections of the compressor or turbine wheel is machined using a rotating milling tool on the workpiece, wherein the workpiece is accommodated in a workpiece support and is fastened relative thereto for the production process.

### BACKGROUND OF THE INVENTION

So-called compressor wheel (impellers) or turbine wheels (blisk) are produced both by casting methods and also by machining production methods on machine tools. In this case, it is usual that in particular compressor and turbine wheels having simpler geometry, such as are frequently used for example in the automobile area, are produced by economical casting methods. Apart from complex geometries which are not castable or only castable at great expense, the limits of the manufacturability by casting are also reached by the increasingly frequently used non-castable materials. A trend towards the increased application of the manufacture of compressor and turbine wheels using machine tools can thus be ascertained.

In these conventional production process it is usual to produce the compressor or turbine wheel in two partial process. The outer contour and the portion required for subsequent mounting in a compressor or a turbine is produced in the first partial process. This partial process is frequently carried out on turning machines. In the second partial process, the blank thus pre-machined is brought onto a milling machine to produce the geometries of the compressor or turbine wheels. For this purpose, clamping devices must be provided in the milling machine which sufficiently stably clamp the respective workpiece within the smallest tolerances and for the machining Furthermore, the clamping devices must be designed so that during the at least five-axis milling process no collision can occur between the clamping device and the tool or machine. For this purpose, the clamping devices are usually designed so that the clamping of the workpiece is effected on the already pre-fabricated mounting parts of the workpiece.

With the known machine tools which are suitable for such a machining task, various methods (adapted according to the type of workpiece) are used for this. Most frequently, the semi-finished blanks are either screwed directly onto suitably prepared devices in the machine or screwed firmly to a workpiece support (pallet) outside the machine and then either brought directly into the machining space of the machine tool or into an automated magazine system into the machines. For this purpose the workpiece usually has a through-hole through which a stud bolt of the pallet is guided. The workpiece is then clamped in the axial direction towards the pallet by means of a nut which is screwed manually onto the free end of the stud bolt.

Solutions are also known when using workpiece supports in which active clamping elements are provided on the workpiece supports themselves with which the workpieces are then clamped. In addition, solutions are also known in which the workpieces are clamped by means of handling systems directly on a, usually hydraulically or pneumatically actuated, clamping system in the machining space of the machine. These clamping systems are usually designed as cheek clamping devices or as clamping rings for external clamping on the blank or as clamping mandrels for internal clamping in existing holes. The longitudinal axes of these holes usually run in alignment with the axis of rotation of the finished compressor or turbine wheel.

All these clamping methods either require a very high expenditure on equipment and high apparatus costs or give rise to very high installation costs and a high assembly expenditure when refitting the installation for new types of workpiece. This consequently results either in a high staffing expenditure for operating the machines and installations, or the installations and methods are only suitable to a limited extent for automation of the production process which can be implemented and operated economically. In particular, refitting the installation for new types of workpieces can generally only be accomplished completely manually and therefore results in setting up costs. The economic viability of such production methods is therefore not satisfactory.

### SUMMARY OF THE INVENTION

It is therefore the object of the invention to improve the economic viability of the production method specified initially.

This object is achieved in a method of the type specified initially according to the invention whereby in a positioning step the workpiece is placed, by means of a positioning aid or a positioning means, in a certain position within the workpiece support, said position being used for a subsequent production process and being at least radially predetermined relative to a longitudinal axis of the workpiece support, and the workpiece is fastened within the machine tool in an axial direction relative to the workpiece support in a clamping step that differs from the positioning step.

The object is additionally achieved by a compressor wheel or turbine wheel clamping device according to features of the invention.

The invention therefore provides that in at least two preparation or setting up steps, the workpieces are arranged in a workpiece support receptacle suitable for milling machining in a milling machine tool and fixed therein. In this case, in the preceding positioning step in time, the workpiece in the workpiece support is aligned at least in relation to the longitudinal axis or another reference value in a radially correct position (radially correct in relation to a predefined in longitudinal axis of the workpiece support). Fixing in the direction of the longitudinal axis of the workpiece support after completion of the positioning step and before insertion of the equipped workpiece support into the machine tool does not yet take place. This independent process step “positioning step” should therefore take place outside the machine tool, whereby setting up time in the machine tool can advantageously be reduced. During this process the machine tool can therefore further be used productively for machining other workpieces. Since it is merely necessary to insert the workpiece in a predetermined rotational position in and in relation to the workpiece support for carrying out this process step, it is particularly suitable for automation, for example, to be carried out without an operator by means of a handling device such as a robot. The workpiece support for its part can then be inserted at a later time in a likewise predetermined position in a workpiece receptacle of the respective machine tool. The insertion of the equipped workpiece support can preferably also be carried out in an automated manner by means of a handling device.

In the preferably subsequent clamping step, the workpieces are only then fixed in the axial direction, where the clamping step should take place in the machine tool. The clamping direction can preferably also be effected in an automated manner. This division into inherently simple partial process steps to be carried out successively allows a higher degree of automation and in particular a reduction in unproductive auxiliary process times of the machine tools.

For carrying out the clamping step, the workpiece support preferably with the workpiece already radially pre-positioned in relation to the longitudinal axis but preferably otherwise loosely arranged, should thus be brought to a location different to that for carrying out the process step, wherein only the clamping step is carried out here. The clamping step following the positioning step can preferably be carried out at a location other than the positioning step, in particular in the machine tool itself. In connection with the invention, it is therefore particularly preferred if a tailstock which is present anyway in many milling machines but has not yet been used so far in connection with one-piece compressor or turbine wheels, is used for the clamping step.

For this purpose the workpiece carrier can first be inserted in a workpiece receptacle of the machine tool with the workpiece already aligned in the radial direction with respect to the workpiece carrier. The tailstock is then moved on the workpiece in the axial direction and a pressing element is pressed by means of the tailstock against the hitherto free front side of the workpiece. The workpiece is (only) hereby clamped in the machine tool between the tailstock and a contact surface of the workpiece support. The clamping force and friction force hereby produced should be sufficiently large that the ensuring axial and tangential machining forces can be absorbed by the non-positive connection. The method according to the invention thus allows the supply of clamping elements, such as screws or nuts, for example, and their mounting on the workpiece during the setting up process to be at least largely and preferably completely dispensed with. This also contributes to achieving an inexpensive automation of the production process.

Tailstocks have been used so far primarily in workpieces which have a large length in relation to their radial extension and therefore tend to deflect during cutting machining In the case of compressor and turbine wheels however, the ratios of the dimensions of these workpieces are usually precisely the reverse, i.e. the components usually have a small axial length in relation to their radial extension. Another difference from previous applications can be seen in that so far tailstocks have only had a supporting effect in holding the workpiece, in particular to reduce bending deflections of the workpieces. In connection with the invention, however, the tailstock should preferably be used as a single clamping or bracing element by which means a clamping force of the workpiece on the workpiece support is produced. Preferably however, the tailstock can also be provided as that clamping element which provides at least a predominant fraction of the clamping force. At least for certain expedient embodiments of the invention, the tailstock can be used for producing the only forces which counteract the machining forces acting in the circumferential direction. A complete new use of tailstocks is therefore provided according to the invention.

In connection with the invention, an embodiment of the positioning step is particularly suitable in which the positioning is achieved by means of a form closure between the workpiece and the workpiece support. The form closure should be effected in radial directions at least in relation to the longitudinal or rotational axis of the compressor or turbine wheel. In a preferred embodiment, for this purpose the workpiece support and the respective workpiece can be provided with a recess and a pin-like positioning means for engagement in the recess. As a result of its easy machinability, the recess can be assigned to the workpiece and the positioning means having a suitable geometrical shape for engagement can be assigned to the workpiece support. Solutions with the reverse assignment are naturally also possible.

In a preferred further development, a securing of the workpiece against rotary movements in the circumferential direction of the workpiece can be additionally achieved merely by carrying out the positioning step. A suitable embodiment for this purpose can provide a positioning means which has a cross-sectional shape which differs from circular. Naturally in these embodiments, a recess suitable for the positioning means in size, geometrical shape and production accuracy can also be provided. In such embodiments according to the invention, at least a considerable proportion, preferably all the tangentially and radially acting forces are removed by the positioning means by means of a form closure with the workpiece. The usual active clamping elements which have frequently been used hitherto to achieve this effect for clamping the workpiece on the workpiece support are not absolutely necessary in connection with the invention, and their function to achieve a clamping force is taken over at least primarily in particular by the machine-tool side tailstock. The low apparatus costs achieved as a result contribute towards the particular economic viability of the embodiments according to the invention.

In further embodiments, clamping mandrels can also be provided as positioning means which, when actuated abut against the wall surface of the recess in which the respective clamping mandrel is located.

Despite the complexity of the contours to be fabricated and even when there is a plurality of workpieces of different size and shape, the method according to the invention allows so-called chaotic production. In such a process different workpieces are produced on a machine tool without refitting work in an almost arbitrary and quick-turnaround sequence. In order to achieve the fastest possible change, a plurality of workpiece supports can be supplied with workpieces in a workpiece magazine which have already been arranged thereon in a positioning step. Such a workpiece magazine can also be assigned to one or more machine tools. Since in connection with the invention, workpieces can be exchanged very rapidly compared to the processing times usually required, only a small number of workpiece supports is required per workpiece type. In a preferred embodiment in series production of compressor or turbine wheels only two or a few more workpiece supports are provided for a machine tool or a workpiece magazine per workpiece type.

Further preferred embodiment of the invention are obtained from the claims, the description and the drawings.

The invention is explained in detail with reference to exemplary embodiments shown purely schematically in the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 shows a perspective view of a pallet for receiving a workpiece;

FIG. 2 shows the pallet from FIG. 1 with a workpiece arranged thereon;

FIG. 3 shows a machine tool which can be used in connection with the method according to the invention;

FIG. 4 shows a detailed view from FIG. 3 in which a workpiece receptacle of the machine tool is located in the receiving position;

FIG. 5 shows an enlarged detailed view from FIG. 4;

FIG. 6 shows the machine tool from FIG. 3 in which the workpiece receptacle and a tailstock are located in a position provided for milling machining;

FIG. 7 shows an enlarged detailed view from FIG. 6; and

FIG. 8 shows a further enlarged detailed view from FIG. 7.

### DESCRIPTION OF THE PREFERRED EMBODIMENTS

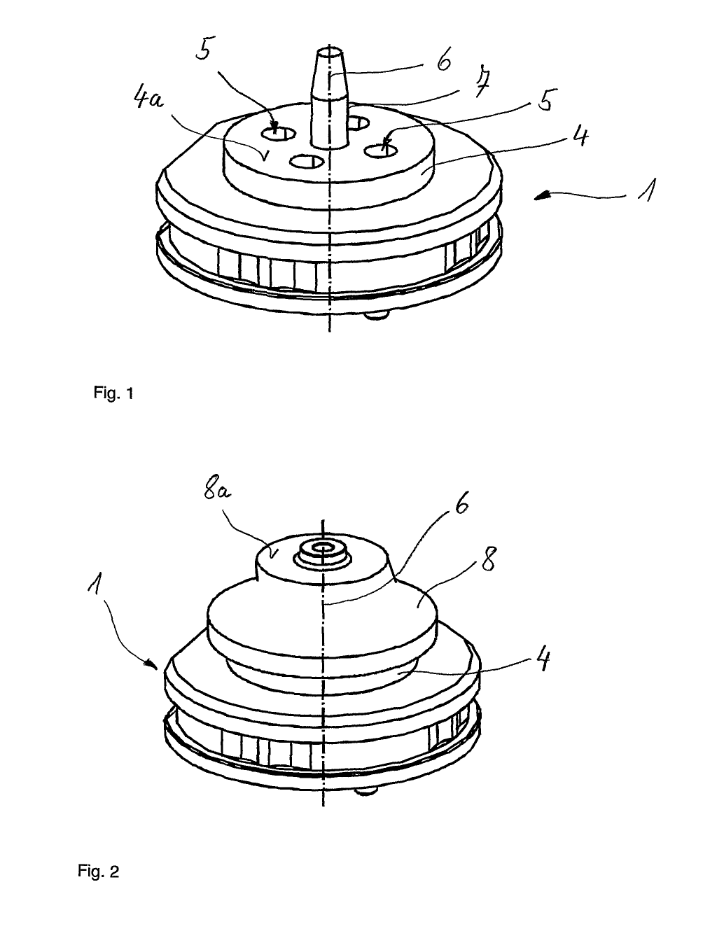

Referring to the drawings in particular, FIG. 1 shows a workpiece support configured as a pallet such as can be used in conjunction with the present invention. This is a standard zero-clamping workpiece pallet such as is supplied for example, by Erowa AG, CH-6233 Biiron and System 3R AG, CH-9230 Flawil, under the designations Erowa-System ITS and Macro Magnum. Such pallets 1 are provided for high-precision and nevertheless automated arrangements in a machine tool 2 as is shown, for example in FIG. 3. Both the machine pallet 1 and also the machine tool 2 each have an interface so that pallets 1 can be reliably held in the machine tool 2 in machining positions by a workpiece receptacle 3 of the machine tool 2.

On the workpiece side of the pallet, a disk-shaped adaptor part 4 is fastened to the pallet. For this purpose, the workpiece-specific adapter part 4 has four holes 5 in which screws not shown in detail are arranged and in which the pallet 1 is screwed. Centrally or coaxially to a longitudinal and rotational axis 6 provided for feed movements, a receiving pin 7 which is shaped conically in section towards its free end and having a circular cross-section is provided in the adapter part 4, which has the function of a positioning means. The receiving pin 7 projects from a flat or planar contact face 4a of the adapter part 4 assigned to the pallet 1, the longitudinal axis 6 of the receiving pin 7 being aligned perpendicularly to the contact face 4a. The receiving pin 7 can be arranged or fastened in a recess in the contact face which cannot be seen in the diagram in FIG. 1, in particular screwed in by means of a thread.

On its underside, the pallet 1 has positioning and clamping aids such as, for example, a clamping pin not shown in detail and an index pin by which means said pallet can be clamped by a clamping device of a machine tool 2. The positioning and clamping aids formed in a manner known per se are part of the interface by which means the pallet is clamped in the machine tool and by which the pallet is secured against relative movements in relation to the workpiece receptacle.

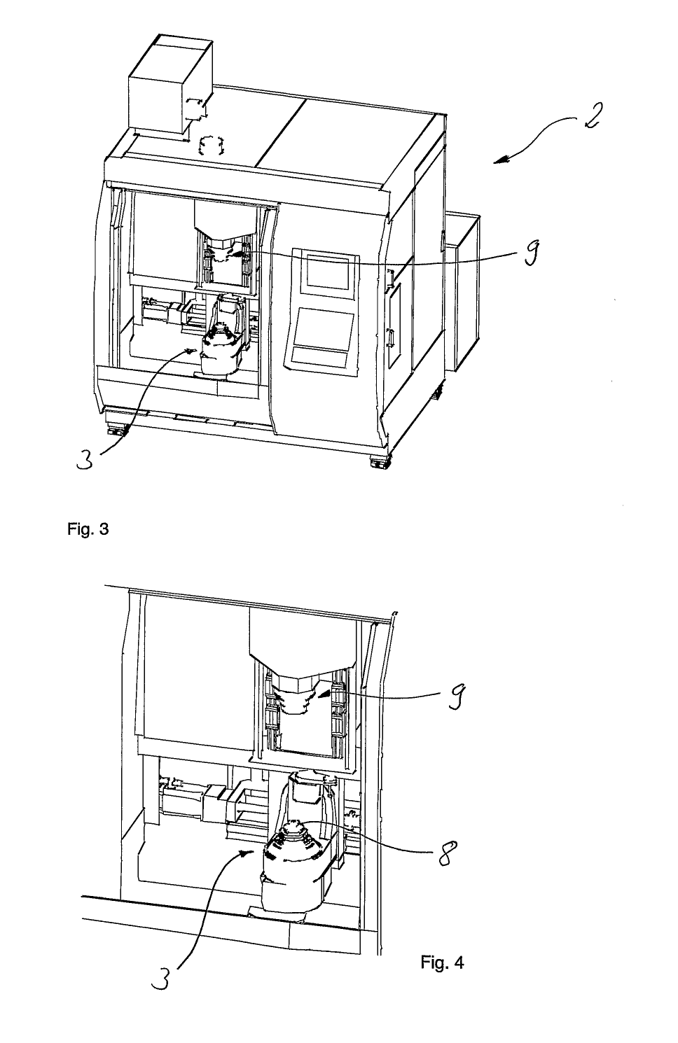

The pallet 1 is provided for receiving workpieces 8 which have already been pre-machined. The pre-machining can in particular comprise turning of a section of a piece of rod material. Due to the turning the workpiece can already have acquired an outer contour which corresponds to the outer contour of the component to be produced. Such a pre-machined workpiece 8 is shown arranged on a pallet 1 in FIG. 2.

For arranging on the pallet 1, the workpiece 8 has an open recess on its front side facing the workpiece support which can preferably be configured as a blind hole or as a through hole. The longitudinal axis of the hole coincides with the subsequent axis of rotation of the compressor or turbine wheel. The contour or geometrical shape of the receiving pin is adapted to or coincides with the hole so that the workpiece 8 comes to abut against the contact face 4a due to the arrangement on the receiving pin 7 and is secured against radial movements in relation to the longitudinal axis 6 of the receiving pin.

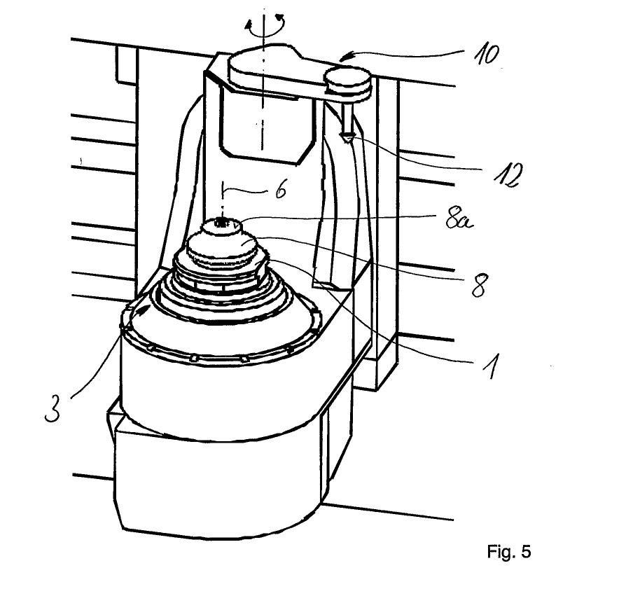

FIGS. 3 to 7 show a machine tool 2 provided for the milling of workpieces which is suitable for five-axis simultaneous machining The machine tool therefore has at least five driven axes which can all be put into use simultaneously or in partial quantities by a controller of the machine tool. In this case, two axes of motion are assigned to the workpiece receptacle 3 and three axes of motion to a workpiece support 9. Such machines provided with at least five driven axes (three translational and two axes of rotation) for producing feed movements are suitable for fabricating compressor and turbine wheels of typical complex geometrical shapes, in particular blade shapes. Such a machine tool is supplied for example by the application under the designation STC 100 and is used in connection with other clamping methods.

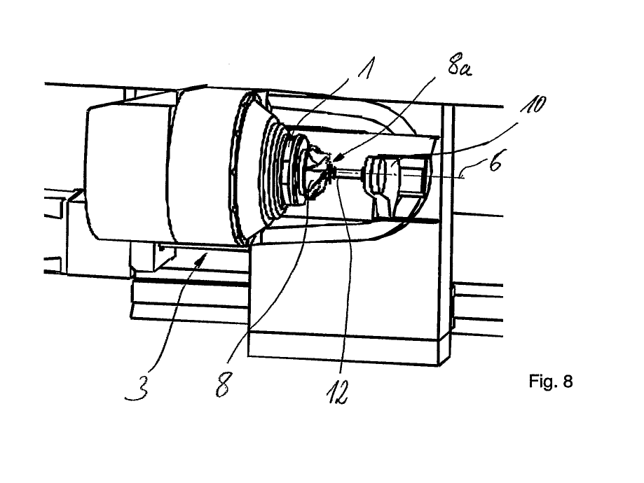

The workpiece support 9 of the machine tool 2 is provided for receiving a milling tool, wherein an axis of rotation 10 of the milling tool in a neutral position of the workpiece support 9 is aligned orthogonally to a workpiece axis of the workpiece receptacle 3 (FIGS. 7 and 8).

The workpiece receptacle 3 is intended for receiving one of the pallets 1 with a workpiece 9 disposed thereon, wherein the workpiece receptacle 3 grasps the pallet via its interface. The workpiece receptacle 3 further comprises a tailstock 10 known per se which can be fed to the workpiece. A universal stop element 12 of the tailstock 10 can additionally be brought into a position by a pivoting movement in which the stop element 12 is aligned with the hole of the workpiece 8. By means of a, for example, hydraulically or pneumatically actuatable cylinder or by means of a spindle drive, the conically shaped stop element 12 can then be inserted in the hole at the free front side 8a of the workpiece and thus brought into abutment against the hitherto free front side of the workpiece. The workpiece 8 is thus clamped between the adapter part 4 and the stop element 12 and thus fixed against axial movements. In this case, however the clamping force should be dimensioned such that the forces occurring during the milling machining are also absorbed in the circumferential direction of the workpiece due to frictional contact.

In the position shown in FIGS. 3 to 5 the workpiece receptacle 3 is located in a receiving position in which the workpiece support configured as a pallet can be received together with a workpiece pre-positioned thereon in horizontal alignment.

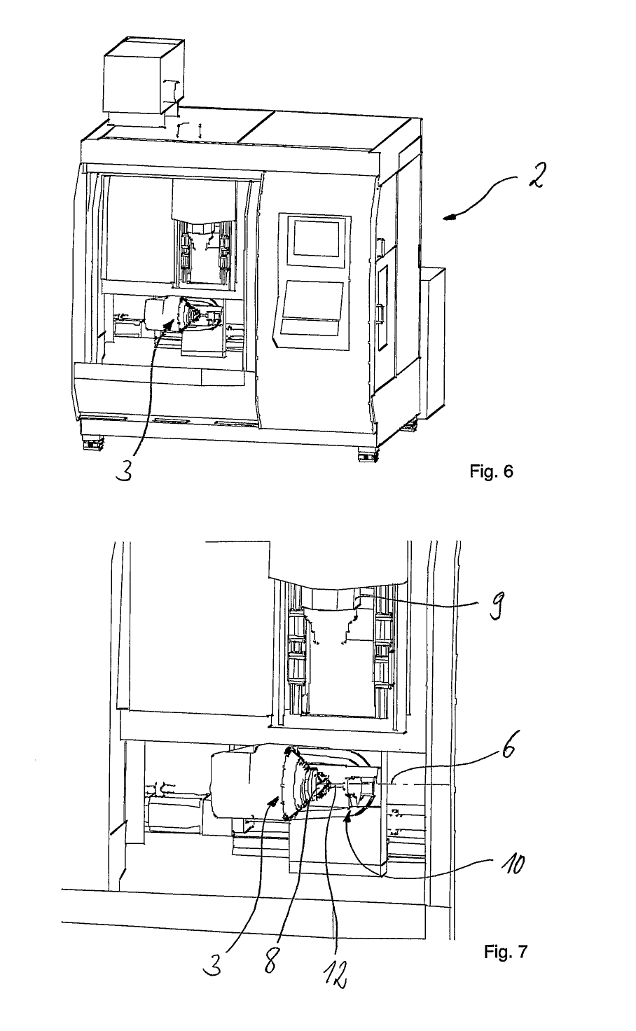

In a first variant of the method according to the invention, the pallet 1 with the adapter part 4 located thereon can already be located in the workpiece receptacle 3 of the machine tool and clamped there. For receiving a workpiece 8, the pallet 1 in the machine tool is brought into the horizontal position shown in FIGS. 3 and 5. In this position the receiving pin 7 is at least substantially perpendicularly aligned.

Now, one of the workpieces 8 which has been pre-machined by turning, can be arranged with its recess or hole on the receiving pin 7 and thus loosely pre-positioned. This arrangement can advantageously be undertaken by an automatic handling device which for this purpose removes such a workpiece from a workpiece store and places in on the receiving pin 7. The conical shape of the receiving pin 7 makes it easier to compensate for any positioning inaccuracies of the automatic handling device and to always achieve exact positioning of the workpieces 8 on the pallet 1.

The tailstock 10 can now be moved towards the workpiece 8, the stop element 12 pivoted to the free front side 8a of the workpiece and inserted into the recess. Due to the form closure with the receiving pin 7 (positioning means) and a frictional contact produced by the sufficiently high clamping force, the workpiece for milling machining is securely and highly precisely held in the machine tool or securely clamped therein. In this clamping the workpiece can be finish-machined. After the end of the machining, the workpiece receptacle 3 is transferred to the horizontal position from FIG. 3 again and the finished compressor wheel is removed manually or by means of the automatic handling device.

The invention allows a plurality of variations, not all of which can be discussed. Thus, in a preferred variant of the method according to the invention, for example, it can be provided that the workpieces are already inserted in a pallet 1 outside the machine tool, preferably in an automated manner. The positioning step carried out in this case can substantially correspond to the positioning step carried out in the machine tool. The respective workpiece support can be arranged in a fitting place not shown in detail at which the workpiece support is equipped with a workpiece.

Finally, the respective pallet can be transferred into a workpiece magazine of the respective machine tool not shown in detail, for example, by means of an automatic handling device. Here also, particularly as a result of the receiving pin 7 functioning as an insertion aid and the clamping or bracing of the workpiece in the axial direction not required at this time, an automated fitting process can be achieved reliably and nevertheless with low expenditure on equipment. The pallets can be brought into the machining position of the machine tool at a time determined by a superordinate production master computer, wherein in this connections its workpieces are clamped with the tailstock against the pallet in the axial direction.

In this embodiment at least two pallets each with an adapter part adapted to the type of workpiece should be provided for meaningful automation and interruption-free production per machine tool for each type of workpiece. The pallets 1 are stored in a pallet magazine and can be equipped with workpieces by a constructively simply configured automatic handling device. In this case, the corresponding workpiece support is preferably positioned at the transfer point shortly before loading the workpiece into the machine tool. This has the advantage that the system thus interlinked allows genuine chaotic production without complex master computers and/or production planning systems.

While specific embodiments of the invention have been described in detail to illustrate the application of the principles of the invention, it will be understood that the invention may be embodied otherwise without departing from such principles.

1. A milling method for machining a workpiece of a compressor or turbine wheel, the method comprising:
providing a machine tool, in which the contour of flow-conducting sections of the compressor or turbine wheel is machined using a rotating milling tool on the workpiece;
accommodating the workpiece in a workpiece support and fastening the workpiece relative thereto for the production process;
in a positioning step, placing the workpiece, by means of a positioning aid, in a certain position within the workpiece support, said position being used for a subsequent production process and being at least radially predetermined relative to a longitudinal axis of the workpiece support; and
fastening the workpiece within the machine tool in an axial direction relative to the workpiece support in a clamping step that differs from the positioning step.

2. The milling method according to claim 1, wherein the positioning step is carried out outside the machine tool.

3. The milling method according to claim 1, wherein the clamping step follows the positioning step in time.

4. The milling method according to claim 1, wherein in the positioning step a positioning of the workpiece in the radial position is produced by means of a form closure with the workpiece support.

5. The milling method according to claim 1, wherein means are used for carrying out the positioning or clamping step by accommodating the workpiece in a workpiece support in an arrangement suitable for milling machining, which means are either already arranged on the workpiece support before supplying the workpiece or are installed on the machine tool.

6. The milling method according to claim 1, wherein the workpiece support and the workpiece have a recess and a pin-like positioning aid for engagement in the recess, wherein the recess is disposed in alignment in relation to the axis of rotation of the compressor or turbine wheel.

7. The milling method according to claim 1, wherein for carrying out the clamping step the workpiece support with the pre-positioned workpiece is disposed at a location which is different from the location at which the clamping step is carried out.

8. The milling method according to claim 1, wherein the workpiece support together with the workpiece is disposed in a milling machine tool for carrying out the clamping step.

9. The milling method according to claim 8, wherein the workpiece is clamped by means of a tailstock in the machine tool.

10. The milling method according to claim 9, wherein a clamping force is exerted with the tailstock, the direction whereof is at least substantially in alignment with the longitudinal axis or at least runs parallel to this.

11. The milling method according to claim 1, wherein on the workpiece side, the workpiece support is provided with an exchangeable adaptor part adapted to the respective type of workpiece and on the machine tool side, it is configured to be compatible with a quick-clamping system.

12. A method for producing a plurality of compressor or turbine wheels, in a milling machine tool, the method comprising the steps of:
providing a machine tool, in which the contour of flow-conducting sections of the compressor or turbine wheel is machined using a rotating milling tool on the workpiece;
accommodating the workpiece in a workpiece support and fastening the workpiece relative thereto for the production process;
in a positioning step, placing the workpiece, by means of a positioning aid, in a certain position within the workpiece support, said position being used for a subsequent production process and being at least radially predetermined relative to a longitudinal axis of the workpiece support; and
fastening the workpiece within the machine tool in an axial direction relative to the workpiece support in a clamping step that differs from the positioning step wherein each of the workpieces provided for manufacturing compressor or turbine wheels is arranged in the machine tool and subsequently milled.

13. The method according to claim 12, further comprising providing a workpiece support buffer in which equipped workpiece supports are brought.

14. The method according to claim 12, wherein the respective workpiece together with the workpiece support is removed from the machine tool, the workpiece is taken from the workpiece support and subsequently the workpiece support is equipped with one of the other workpieces outside the machine tool.

15. A compressor wheel or turbine wheel clamping device for arrangement of a workpiece provided for producing a compressor wheel or turbine wheel in a milling machine tool, which comprises:
a workpiece support which can be moved in and out of the milling machine tool and on which the workpiece can be arranged in a manner suitable for milling;
a positioning means by which means a radial alignment of the workpiece can be produced in relation to a longitudinal axis of the workpiece support; and
a tailstock which can be brought to abut against the workpiece for carrying out the milling machining on the workpiece in order to exert an axial clamping force on the workpiece.

16. The method according to claim 10 wherein the tailstock is provided for clamping a compressor or turbine wheel during milling of flow-conducting elements of the compressor or turbine wheel in a machine tool.
